(19) United States
(12) Patent Application Publication
(10) Pub. No.: US 2026/0161066 A1
(43) Pub. Date: Jun. 11, 2026

(54) PROJECTOR

(71) Applicant: SEIKO EPSON CORPORATION, Tokyo (JP)

(72) Inventor: Koichi AKIYAMA, AZUMINO-SHI (JP)

(21) Appl. No.: 19/181,822

(22) Filed: Apr. 17, 2025

(30) Foreign Application Priority Data
Apr. 18, 2024 (JP) 2024-067317

(51) Int. Cl. G03B 21/20; G02B 27/48; G03B 33/12

(52) U.S. Cl. CPC G03B 21/208; G02B 27/48; G03B 21/2013; G03B 21/2033; G03B 21/2066; G03B 33/12

(57) ABSTRACT

The projector of the present disclosure includes a first light source for emitting a first laser light, a condenser element, a diffusion member into which condensed first laser light is incident, a collimating element that collimates diffused light emitted from the diffusion member, a light intensity distribution change unit configured to change light intensity distribution by splitting, to a peripheral side, at least a part of the central beam of the diffused light incident from the collimating element, a multi-lens array into which light emitted from the light intensity distribution change unit is incident, an light modulation device for modulating light incident from the multi-lens array according to image information, a superimposing lens that superimposes light onto the light modulation device, and a projection optical device that projects the light modulated by the light modulation device, wherein in the light intensity distribution change unit, an angle of incidence of the diffused light with respect to the light intensity distribution change unit before the light intensity distribution is changed, and an angle of emergence of the diffused light with respect to the light intensity distribution change unit after the light intensity distribution is changed are equal.

The present application is based on, and claims priority from JP Application Serial Number 2024-067317, filed Apr. 18, 2024, the disclosure of which is hereby incorporated by reference herein in its entirety.

### BACKGROUND

### 1. Technical Field

The present disclosure relates to a projector.

### 2. Related Art

In recent years, a laser light source has been used as a light source for projectors in order to increase the brightness of image light. In a projector that uses a laser light source, a speckled pattern called speckle noise, which is caused by interference of laser light, is visible on a screen, so a measure is taken to suppress deterioration of display quality caused by speckle noise. For example, in the projector disclosed in JP-A-2011-180281, the laser light is incident on a diffusion element that diffuses the light on and around the optical axis more than the peripheral portion, thereby reducing the speckle noise by homogenizing the spatial distribution of the light intensity at the exit pupil surface of the projection optical system that projects the image light.

However, in the projector disclosed in JP-A-2011-180281, the laser light emitted from a rod integrator passes through the diffusion elements and diffuses. This causes a disturbance in the imaging relationship between the light emitted from the rod integrator and the light modulation device. As a result, there is a problem in that the light modulation devices cannot be illuminated efficiently.

### SUMMARY

In order to overcome the above issue, one aspect of the present disclosure is a projector that includes a first light source for emitting a first laser light; a condenser element configured to condense the first laser light; a diffusion member onto which the first laser light condensed by the condenser element is incident; a collimating element that collimates diffused light emitted from the diffusion member; a light intensity distribution change unit configured to change light intensity distribution of the diffused light by splitting, to a peripheral side, at least a part of the central beam of the diffused light incident from the collimating element; a multi-lens array into which the light emitted from the light intensity distribution change unit is incident; a light modulation device for modulating light incident from the multi-lens array according to image information; a superimposing lens that superimposes the light emitted from the multi-lens array into the light modulation device; and a projection optical device that projects light modulated by the light modulation device, wherein in the light intensity distribution change unit, an angle of incidence of the diffused light with respect to the light intensity distribution change unit before the light intensity distribution is changed, and an angle of emergence of the diffused light with respect to the light intensity distribution change unit after the light intensity distribution is changed are equal.

### BRIEF DESCRIPTION OF THE DRAWINGS

FIG. 1 is a schematic diagram showing a configuration of projector 1 according to a first embodiment.

FIG. 2 is a schematic configuration diagram of the illumination device.

FIG. 3 is a diagram showing an example of a method of manufacturing a light intensity distribution change unit.

FIG. 4 is a diagram showing a main structure of the light intensity distribution change unit, and its operation.

FIG. 5 is a diagram showing a main structure of the light intensity distribution change unit of a second embodiment.

### DESCRIPTION OF EMBODIMENTS

Hereinafter, embodiments of the present disclosure will be described with reference to the drawings. In the drawings, in order to make each component easy to see, the scale of dimensions may be changed depending on the component.

### First Embodiment

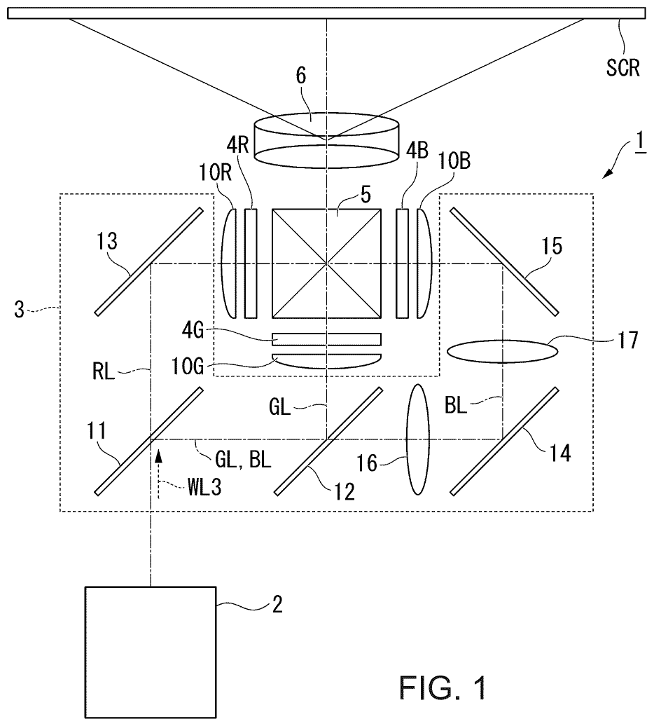

A projector according to a first embodiment of the present disclosure will be described. FIG. 1 is a schematic diagram showing a configuration of a projector 1 of the present embodiment. As shown in FIG. 1, the projector 1 of the present embodiment is a projection-type image display device that displays an image on a screen SCR. The projector 1 is equipped with an illumination device 2, a color separation optical system 3, light modulation devices 4R, 4G, and 4B, a color combining optical system 5, and a projection optical device 6. The projector 1 is a three-plate type projector having three light modulation devices.

The illumination device 2 emits illumination light WL3 toward the color separation optical system 3. The illumination light WL3 includes red illumination light RL, green illumination light GL, and blue illumination light BL. The configuration of the illumination device 2 will be described later.

The color separation optical system 3 separates the illumination light WL3 into red illumination light RL, green illumination light GL, and blue illumination light BL. The color separation optical system 3 is equipped with, for example, a first dichroic mirror 11, a second dichroic mirror 12, a first reflective mirror 13, a second reflective mirror 14, a third reflective mirror 15, a first relay lens 16, and a second relay lens 17.

The first dichroic mirror 11 is arranged on the optical path of the illumination light WL3 emitted from the illumination device 2 and separates the incident illumination light WL3 into red illumination light RL, and green illumination light GL and blue illumination light BL. The first dichroic mirror 11 transmits the red illumination light RL and reflects the green illumination light GL and the blue illumination light BL. The second dichroic mirror 12 is arranged on a common optical path of the green illumination light GL and the blue illumination light BL emitted from the first dichroic mirror 11, and separates the green illumination light GL and the blue illumination light BL. The second dichroic mirror 12 transmits the blue illumination light BL and reflects the green illumination light GL.

The first reflective mirror 13 reflects the red illumination light RL toward the light modulation device 4R. The second reflective mirror 14 and the third reflective mirror 15 guide the blue illumination light BL to the light modulation device 4B. The green illumination light GL is reflected from the second dichroic mirror 12 toward the light modulation device 4G.

The first relay lens 16 is arranged on the optical path of the blue illumination light BL between the second dichroic mirror 12 and the second reflective mirror 14. The second relay lens 17 is arranged on the optical path of the blue illumination light BL between the second reflective mirror 14 and the third reflective mirror 15. By arranging the first relay lens 16 and the second relay lens 17 as described above, light loss of the blue illumination light BL is compensated. The light loss of the blue illumination light BL is caused by the fact that an optical path length of the blue illumination light BL from the first dichroic mirror 11 to the light modulation device 4B is longer than an optical path length of the red illumination light RL from the first dichroic mirror 11 to the light modulation device 4R and an optical path length of the green illumination light GL from the first dichroic mirror 11 to the light modulation device 4G.

The light modulation device 4R is arranged on the optical path of the red illumination light RL that is reflected by the first reflective mirror 13 and is emitted from the first reflective mirror 13. The light modulation device 4R modulates the incident red illumination light RL according to image information input from an image input device (not shown), forms red image light, and emits red image light. The light modulation device 4G is arranged on the optical path of the green illumination light GL that is reflected by the second dichroic mirror 12 and is emitted from the second dichroic mirror 12. The light modulation device 4G modulates the incident green illumination light GL according to image information input from the image input device (not shown), forms green image light, and emits green image light. The light modulation device 4B is arranged on the optical path of the blue illumination light BL that is reflected by the third reflective mirror 15 and emitted from the third reflective mirror 15. The light modulation device 4B modulates the incident blue illumination light BL according to image information input from the image input device (not shown), forms blue image light, and emits blue image light. For example, a personal computer or a portable terminal device is used for the image input device.

For example, a transmission type liquid crystal panel is used for each of the light modulation devices 4R, 4G, and 4B. A polarizing plate (not shown) is arranged on each of the incident side and the emission side of the liquid crystal panels. A field lens 10R is arranged on the optical path of the red illumination light RL between the first reflective mirror 13 and the light modulation device 4R. A field lens 10G is arranged on the optical path of the green illumination light GL between the second dichroic mirror 12 and the light modulation device 4G. A field lens 10B is arranged on the optical path of the blue illumination light BL between the third reflective mirror 15 and the light modulation device 4B.

The color combining optical system 5 is arranged across the optical path of the red image light emitted from the light modulation device 4R, the optical path of the green image light emitted from the light modulation device 4G, and the optical path of the blue image light emitted from the light modulation device 4B. When viewed in plan view as shown in FIG. 1, or when viewed in side view, a combining position of color light in the color combining optical system 5 overlaps with the intersection of the optical paths of the red image light, the green image light, and the blue image light. In the color combining optical system 5, the red image light, the green image light, and the blue image light are combined with each other to form the color image light. The color combining optical system 5 emits the color image light. For example, a cross dichroic prism is used for the color combining optical system 5.

The projection optical device 6 is arranged on the optical path of the color image light emitted from the color combining optical system 5. The color image light emitted from the color combining optical system 5 corresponds to the light that is modulated by the light modulation devices 4R, 4G, and 4B. The projection optical device 6 enlarges and projects the color image light emitted from the color combining optical system 5 and incident thereon toward the screen SCR. The color image light enlarged and projected from projection optical device 6 is displayed as a color image on the display surface of the screen SCR, which faces the emission surface of projection optical device 6.

The projection optical device 6 is composed of, for example, multiple optical lenses, but it may also be composed of a single optical lens. For example, the optical lens includes various lenses such as a plano convex lens, a biconvex lens, a meniscus lens, an aspherical lens, a rod integrator lens, and a free-form surface lens.

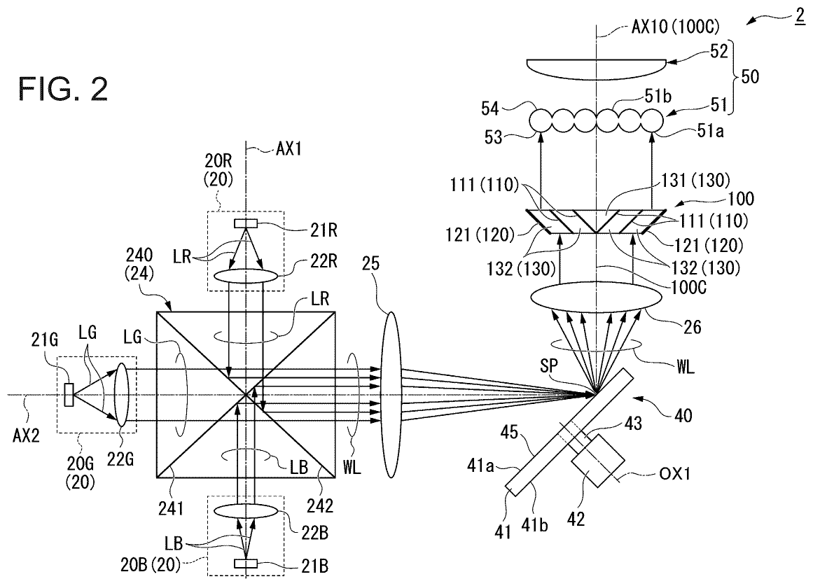

Next, the configuration of illumination device 2 will be described. FIG. 2 is a schematic configuration diagram of the illumination device 2. As shown in FIG. 2, the illumination device 2 is equipped with a first light source 20R, a second light source 20G, a third light source 20B, a light combining member 24, a condenser element 25, a diffusion device 40, a collimating element 26, a light intensity distribution change unit 100, and a superimposition optical system 50 composed of a multi-lens array 51 and a superimposing lens 52.

The first light source 20R has a first laser element 21R and a first collimating lens 22R, and emits red light LR. The first laser element 21R emits red light LR, which is laser light. The red light LR has a wavelength band that includes wavelengths belonging to the red color in the visible wavelength band, for example, a wavelength band of 585 nm to 720 nm. The red light LR is radially emitted from the first laser element 21R around an optical axis AX1 as the center. Note that the red light LR corresponds to a first laser light.

The first collimating lens 22R is arranged on the optical path of the red light LR emitted from the first laser element 21R and on the optical axis AX1. The center of the first collimating lens 22R in a direction perpendicular to the optical axis AX1 substantially overlaps with the optical axis AX1. The first collimating lens 22R collimates the incident red light LR.

The second light source 20G has a second laser element 21G and a second collimating lens 22G, and emits green light LG. The second laser element 21G emits green light LG. The green light LG has a wavelength band that includes wavelengths belonging to the green color in the visible wavelength band, for example, a wavelength band of 495 nm to 585 nm. The green light LG corresponds to a second light. The green light LG corresponds to a second laser light that has a different wavelength band that from that of the red light LR.

The green light LG is radially emitted from the second laser element 21G around an optical axis AX2 as the center. When viewed in plan view as shown in FIG. 2, or when viewed in side view, the optical axis AX2 that extends from the second laser element 21G to a combining position of color light in the light combining member 24 (to be described later) is orthogonal to the optical axis AX1 that extends from the first laser element 21R to the combining position of color light in the light combining member 24.

The second collimating lens 22G is arranged on the optical path of the green light LG emitted from the second laser element 21G and on the optical axis AX2. The center of the second collimating lens 22G in a direction perpendicular to the optical axis AX2 substantially overlaps with the optical axis AX2. The second collimating lens 22G collimates the incident green light LG.

The third light source 20B has a third laser element 21B and a third collimating lens 22B, and emits blue light LB. The third laser element 21B emits the blue light LB. The blue light LB has a wavelength band including wavelengths belonging to blue color in the visible wavelength band, for example, a wavelength band of 380 nm to 495 nm. The blue light LB is radially emitted from the third laser element 21B around the optical axis AX1 as the center. The optical axis AX1 of the blue light LB is collinear with the optical axis AX1 of the red light LR. The optical axis AX1 of the blue light LB is an axis obtained by extending the optical axis AX1 of the red light LR toward the light combining member 24 so as to pass through the combining position of color light in the light combining member 24, and further extending that optical axis AX1 to the side opposite to the first light source 20R with respect to the light combining member 24. The blue light LB is emitted parallel to and in the opposite direction of the red light LR with respect to the light combining member 24.

Note that in FIG. 2, each of the first light source 20R, the second light source 20G, and the third light source 20B is equipped with one laser light source and one collimating lens, but the number and relative arrangement of the laser light sources and the collimating lenses in these light sources are not particularly limited. For example, each of the first light source 20R, the second light source 20G, and the third light source 20B may be equipped with two or more laser light sources and the same number of collimating lenses as the laser light sources. Each of the first light source 20R, the second light source 20G, and the third light source 20B may have a member other than the laser light source and the collimating lens, such as a package that holds the laser light source and the collimating lens.

The light combining member 24 is arranged across the optical path of the red light LR that is emitted from the first light source 20R, the optical path of the green light LG that is emitted from the second light source 20G, and the optical path of the blue light LB that is emitted from the third light source 20B. When viewed in plan view as shown in FIG. 2, or when viewed in side view, the combining position of color light in the light combining member 24 overlaps with the intersection of the optical path of the red light LR, the optical path of the green light LG, and the optical path of the blue light LB. In other words, the combining position of color light overlaps with the intersection of the optical axis AX1 and the optical axis AX2.

In the light combining member 24, the incident red light LR, green light LG, and blue light LB are combined with each other, and white light WL is generated. The white light WL corresponds to combined light. The light combining member 24 emits the white light WL along an optical axis AX2. The optical axis AX2 of the white light WL is collinear with the optical axis AX2 of the green light LG. The optical axis AX2 of the white light WL is an axis obtained by extending the optical axis AX2 of the green light LG toward the light combining member 24 so as to pass through the combining position of color light in the light combining member 24, and further extending toward the side opposite to the second light source 20G with respect to the light combining member 24.

For example, a cross dichroic prism 240 is used for the light combining member 24. The cross dichroic prism 240 has a first dichroic mirror 241 and a second dichroic mirror 242. In plan view or side view in which the optical axis AX1 and optical axis AX2 are orthogonal to each other, the reflection surface of the first dichroic mirror 241 and the reflection surface of the second dichroic mirror 242 are each inclined with respect to the optical axis AX1 and the optical axis AX2. In the plan view or the side view, the angle formed by each of the reflection surfaces of the first dichroic mirror 241 and the second dichroic mirror 242 and each of the optical axes AX1 and AX2 is 45°. In plan view or side view in which the optical axes AX1 and AX2 are orthogonal, the reflection surface of the first dichroic mirror 241 and the reflection surface of the second dichroic mirror 242 are orthogonal to each other.

The first dichroic mirror 241 reflects the blue light LB and transmits the green light LG and the red light LR. The second dichroic mirror 242 reflects the red light LR and transmits the blue light LB and the green light LG. The red light LR emitted from the first light source 20R is incident on the second dichroic mirror 242 along the optical axis AX1. The red light LR is reflected by the second dichroic mirror 242, and is emitted to the side opposite to the second light source 20G along the optical axis AX2, and then passes through the first dichroic mirror 241. The green light LG emitted from the second light source 20G is incident on the first dichroic mirror 241 along the optical axis AX2. The green light LG goes straight, and passes through the first dichroic mirror 241 and the second dichroic mirror 242. The blue light LB emitted from the third light source 20B is incident on the first dichroic mirror 241 along the optical axis AX1. The blue light LB is reflected by the first dichroic mirror 241, and is emitted to the side opposite to the second light source 20G along the optical axis AX2, and then passes through the second dichroic mirror 242.

As described above, the red light LR, the green light LG, and the blue light LB emitted from the first dichroic mirror 241 and the second dichroic mirror 242 are combined with each other to generate white light WL. The white light WL is emitted along the optical axis AX2 from the side surface of the cross dichroic prism 240 that is opposite to the side surface facing the second light source 20G.

The condenser element 25 is arranged on the optical path of the white light WL between the light combining member 24 and the diffusion device 40. The condenser element 25 condenses the white light WL toward the diffusion device 40 in a state of being emitted from the light combining member 24 and collimated. The center of the condenser element 25 in a direction perpendicular to the optical axis AX2 substantially overlaps with the optical axis AX2. The condenser element 25 is, for example, a biconvex lens, but may be an optical element with a light condensing function other than the biconvex lens, may be a plano convex lens, or may be constituted by multiple optical lenses.

The diffusion device 40 is arranged on the optical path of the white light WL emitted from the condenser element 25. The diffusion device 40 diffuses and emits the incident white light WL while being condensed by the condenser element 25. The diffusion device 40 is, for example, a reflecting type diffusion device, and diffuses and reflects the incident white light WL.

The diffusion device 40 has a diffusion member 41 composed of a diffusion plate and a drive device 42. The diffusion member 41 has an incident surface 41a onto which the white light WL is irradiated while being condensed by the condenser element 25, and has a back surface 41b that is an opposite side surface of the incident surface 41a. The diffusion member 41 is arranged so that the incident surface 41a faces the condenser element 25. In plan view or side view in which the optical axis AX1 and the optical axis AX2 are orthogonal to each other, the angle formed by the incident surface 41 a and the optical axis AX2 is 45°.

The diffusion member 41 is mounted on the drive device 42 in a rotatable state around a rotation axis OX1. The drive device 42 rotates the diffusion member 41 around the rotation axis OX1. The drive device 42 is, for example, a motor. Note that the drive device 42 may be any device that can rotate the diffusion member 41 as described above, and is not limited to a motor.

In the diffusion device 40, a light condensed spot SP of the white light WL is formed on the incident surface 41a of the diffusion member 41. The incident surface 41a has a scattering surface with an irregularity structure that scatters the white light WL. The white light WL diffused by the diffusion member 41 is emitted from the light condensed spot SP as diffused light, and is incident on the collimating element 26. Hereinafter, the white light WL emitted from the diffusion device 40 is referred to as diffused light WL1.

In the projector 1 according to the present embodiment, since each color light LR, LG, and LB included in the white light WL is coherent light, there is a possibility that light interference may occur. The illumination device 2 of the present embodiment causes the white light WL to be diffused by the diffusion member 41 of the diffusion device. By this, the light distribution of the light projected onto the screen SCR is homogenized, and speckle noise is reduced. In addition, by rotating the diffusion member 41, the spatial distribution of speckle noise that changes from moment to moment is superimposed over time, and speckle noise is further reduced.

However, it is difficult to sufficiently reduce speckle noise using only diffusion of light. The present discloser has paid attention to the fact that speckle noise can be reduced by adjusting the light intensity distribution of the exit pupil image of the projection lens of the projector. Specifically, the present discloser has completed the projector 1 of the present embodiment that is capable of reducing speckle noise by adjusting the light intensity distribution of the exit pupil image so that the light intensity of the peripheral portion is higher than that of the central portion. Hereinafter, the white light WL emitted from the diffusion device 40 is referred to as diffused light WL1.

The projector 1 of the present embodiment is equipped with a light intensity distribution change unit 100 that changes the light intensity distribution of the diffused light WL1 by splitting at least a part of the central beam of the diffused light WL1 to the peripheral side.

The projector 1 of the present embodiment collimates the diffused light WL1 by the collimating element 26 and makes it incident on the light intensity distribution change unit 100. The principal light ray of the diffused light WL1 coincides with an optical axis AX10 of the collimating element 26. The collimating element 26 is, for example, a biconvex lens, but may be an optical element with a light condensing function other than the biconvex lens, may be a plano convex lens, or may be constituted by multiple optical lenses. Note that when the collimating element 26 is composed of a single optical lens, collimation accuracy can be further improved by using an aspherical lens.

Hereinafter, a configuration of the light intensity distribution change unit 100 will be described. The light intensity distribution change unit 100 has a beam transfer section 110, a reflection section 120, and a plurality of prisms 130. The beam transfer section 110 is arranged symmetrically with respect to an optical axis 100C that passes through the center of the light intensity distribution change unit 100. Note that the optical axis 100C of the light intensity distribution change unit 100 coincides with the optical axis AX10 of the collimating element 26.

The beam transfer section 110 transfers at least a part of beam of the light incident in a direction away from the optical axis 100C. The beam transfer section 110 has a plurality of optical elements 111. The plurality of optical elements 111 are arranged side by side in a direction orthogonal to the optical axis 100C. In the present embodiment, the two optical elements 111 are arranged so as to be line-symmetrical with respect to the optical axis 100C. In other words, the beam transfer section 110 has four optical elements 111. Note that the number of optical elements 111 that compose the beam transfer section 110 is not limited to the above, and can be changed as appropriate in accordance with the structure of the light intensity distribution change unit 100.

Each optical element 111 is composed of a partially transmissive mirror that transmits part of the incident light and reflects the other part of the incident light. In the present embodiment, each optical element 111 is composed of a so-called half mirror that transmits half of the incident light and reflects the other half. Note that the ratio of the transmittance to reflectance of the incident light in the partially transmissive mirror is not limited to fifty-fifty, for example, the transmittance can be higher or lower than the reflectance. The ratio can be appropriately changed according to the required optical properties for the optical element 111.

The reflection section 120 is arranged on a side opposite to the optical axis 100C with respect to the beam transfer section 110, and reflects light separated by the beam transfer section 110 in the direction along the optical axis 100C. The reflection section 120 has a pair of mirrors 121. Each mirror 121 is arranged in a direction orthogonal to the optical axis 100C. Each mirror 121 is composed of a thin film such as a metal film or a dielectric multilayer film. In the present embodiment, the pair of mirrors 121 are arranged so as to sandwich both ends of the beam transfer section 110 in the direction orthogonal to the optical axis 100C.

The plurality of prisms 130 hold the plurality of optical elements 111 and the plurality of mirrors 121. The plurality of prisms 130 include a single first prism 131 and a plurality of second prisms 132. The first prism 131 and the plurality of second prisms 132 are arranged side by side in a direction orthogonal to the optical axis 100C. The first prism 131 is composed of a triangular prism with a triangular cross-sectional shape. In the present embodiment, the first prism 131 is composed of two transparent substrates bonded together as will be described later, but it may be composed of a single transparent member. Each of the second prisms 132 is composed of a square prism having a parallelogram cross-sectional shape. The first prism 131 is arranged on the optical axis 100C, and the second prisms 132 are arranged on both sides of the first prism 131, so as to sandwich the first prism 131, two on each side in a direction that is orthogonal to the optical axis 100C. The first prism 131 and the second prisms 132 are arranged so that their side surfaces are joined together to form a trapezoidal cross-sectional shape as a whole. Note that the number of prisms 130 is not limited to the above, and can be appropriately changed according to the structure of the light intensity distribution change unit 100, for example, the number of optical elements 111.

Each optical element 111 is arranged so as to be sandwiched between the first prism 131 and a second prism 132, or between two second prisms 132. Each mirror 121 is arranged on the pair of second prisms 132 that, among the plurality of second prisms 132, is most distant from the optical axis 100C in the direction orthogonal to the optical axis 100C. Each optical element 111 and each mirror 121 are arranged so as to form an angle of 45 degrees with respect to the optical axis 100C.

The light intensity distribution change unit 100 of the present embodiment is composed of a prism array of a plurality of optical elements 111 and a plurality of mirrors 121 held by the plurality of prisms 130. Therefore, it is possible to realize a structure in which a plurality of optical elements 111 and a plurality of mirrors 121 are accurately arranged at a predetermined position with respect to the optical axis 100C.

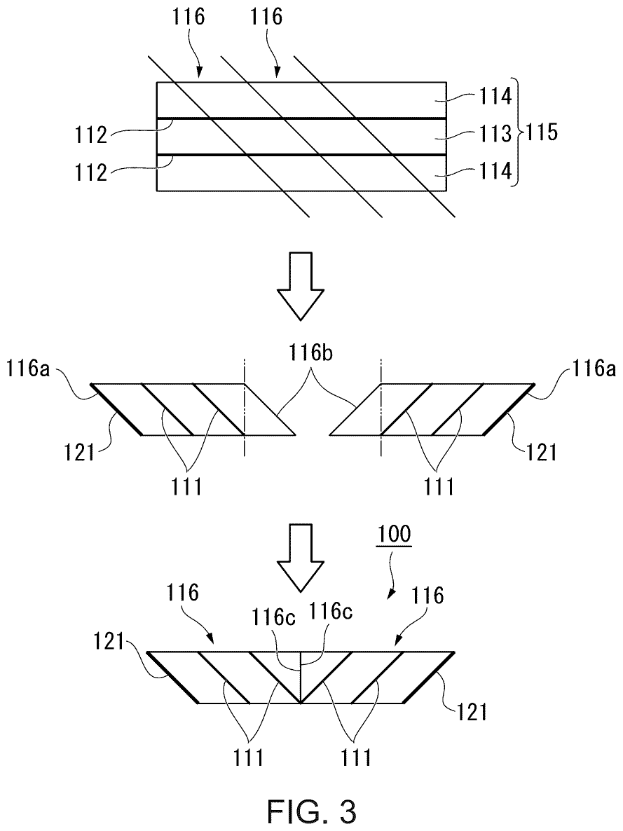

Here, a method of manufacturing the light intensity distribution change unit 100 will be described. FIG. 3 is a diagram showing an example of a manufacturing method of the light intensity distribution change unit 100. As shown in FIG. 3, an optical film 112 that constitutes the optical element 111 is formed on both surfaces of a transparent substrate 113, and the transparent substrate 113 is sandwiched between two transparent substrates 114 to form a laminated body 115 that is composed of three transparent substrates, and then the laminated body 115 is cut at an angle of 45 degrees with respect to the laminated direction to form two optical parts 116. Next, the mirror 121 is formed on the outermost surface 116a of one of the optical parts 116, and the other outermost surface 116b of that optical part 116 is processed into a right-angled surface. The other optical part 116 is processed in the same way. The light intensity distribution change unit 100 of the present embodiment can be produced by joining the right-angle surfaces 116c of the two optical parts 116.

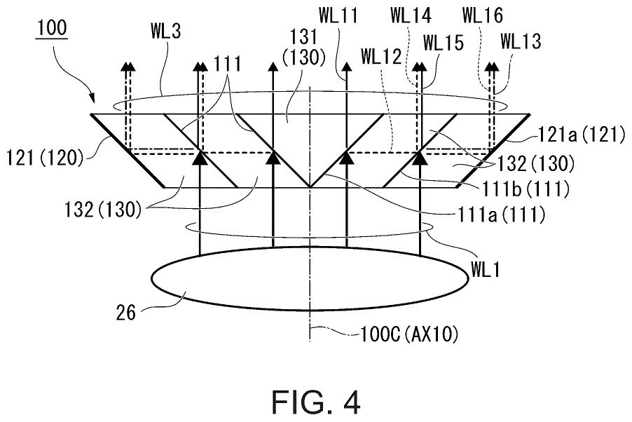

Here, the behavior of the light that was incident on the light intensity distribution change unit 100 will be described. FIG. 4 is a diagram showing the main structure of the light intensity distribution change unit 100, and its operation. As shown in FIG. 4, the diffused light WL1 is incident on the light intensity distribution change unit 100 as a collimated beam that was collimated by the collimating element 26. The diffused light WL1 passes through the multiple prisms 130 and is incident on the multiple optical elements 111.

Hereinafter, in FIG. 4, assuming that, among the plurality of optical elements 111, one of the optical elements 111 held in place by the first prism 131 is referred to as a first optical element 111a, the optical element 111 arranged on the opposite side (right side in FIG. 4) of the first optical element 111a than the optical axis 100C is referred to as a second optical element 111b, and the mirror 121 arranged on the opposite side (right side in FIG. 3) of the second optical element 111b than the optical axis 100C is referred to as a mirror 121a.

A first component WL11, which is a part of the diffused light WL1 that was incident on the first optical element 111a, is emitted from the light intensity distribution change unit 100 by passing through the first optical element 111a and the prism 130, and advances along the optical axis 100C. A second component WL12, which is the other part of the diffused light WL1 that was incident on the first optical element 111a, is reflected by the first optical element 111a in a direction orthogonal to the optical axis 100C and in a direction away from the optical axis 100C, and is incident on the adjacent second optical element 111b by passing through the prism 130.

A third component WL13, which is a part of the second component WL12 that was incident from the first optical element 111a, advances in a direction perpendicular to the optical axis 100C and in a direction away from the optical axis 100C by passing through the second optical element 111b, and is incident on the mirror 121a. A fourth component WL14, which is the other part of the second component WL12 that was incident from the first optical element 111a, is reflected by the second optical element 111b in a direction along the optical axis 100C, is emitted from the light intensity distribution change unit 100 by passing through the prism 130, and advances along the optical axis 100C.

A fifth component WL15, which is a part of the diffused light WL1 that was incident on the second optical element 111b, passes through the second optical element 111b and the prism 130. At this time, the fifth component WL15 combines with the fourth component WL14 reflected by the second optical element 111b to be emitted from the light intensity distribution change unit 100, and advances along the optical axis 100C. A sixth component WL16, which is the other part of the diffused light WL1 that was incident on the second optical element 111b, is reflected by the second optical element 111b in a direction orthogonal to the optical axis 100C and in a direction away from the optical axis 100C, and is incident on the mirror 121a by passing through the prism 130.

The mirror 121a reflects the third component WL13 and the sixth component WL16 incident from the second optical element 111b in a direction along the optical axis 100C. The third component WL13 and the sixth component WL16 reflected by the mirror 121a are emitted from the light intensity distribution change unit 100 by passing through prism 130, and advance along the optical axis 100C.

The light intensity distribution change unit 100 emits the first component WL11 from the portion corresponding to the first optical element 111a, emits the fourth component WL14 and the fifth component WL15 from the portion corresponding to the second optical element 111b, and emits the third component WL13 and the sixth component WL16 from the portion corresponding to the mirror 121a. The light intensity distribution change unit 100 emits the first component WL11, the second component WL12, the third component WL13, the fourth component WL14, the fifth component WL15, and the sixth component WL16 as parallel light along the optical axis 100C.

As described above, the light intensity distribution change unit 100 can split a part of the light incident on the first optical element 111a to the second optical element 111b and the mirror 121a. In the light intensity distribution change unit 100, the first optical element 111a is a portion that is close to the optical axis 100C, and that corresponds to a region where the central beam of the diffused light WL1 is incident.

In the above description, the behavior of light on one side (right side in FIG. 4) with respect to the optical axis 100C has been described, the same can be applied to the behavior of light on the other side (left side in FIG. 4) of the optical axis 100C.

In the present embodiment, since the diffused light WL1 is diffused light emitted from the light condensed spot SP of the diffusion member 41, it has a light intensity distribution in which the light intensity at the center side is higher than that at the peripheral portion. The light intensity distribution change unit 100 of the present embodiment can change the light intensity distribution of the diffused light WL1 by splitting a part of the central beam of the diffused light WL1 incident from the collimating element 26 to the peripheral side to make the light intensity of the central portion of the diffused light WL1 relatively low and the light intensity of the peripheral portion of the diffused light WL1 relatively high.

In addition, the light intensity distribution change unit 100 of the present embodiment can emit the diffused light WL1 as parallel light that was incident as parallel light. In other words, the light intensity distribution change unit 100 ensures that the angle of incidence of the diffused light WL1 to the light intensity distribution change unit 100 before the change of the light intensity distribution is equal to the angle of emergence of the diffused light WL1 from the light intensity distribution change unit 100 after the change of the light intensity distribution. As described above, the light intensity distribution change unit 100 of the present embodiment can change the light intensity distribution without changing the parallel state of the diffused light WL1 before and after incidence.

In the present embodiment, the light intensity distribution change unit 100 is configured with optical elements 111 that are each composed of a partially transmissive mirror, so it is possible to extract the light that has passed through each optical element 111. Therefore, it is possible to suppress the occurrence of problems such as the number of light ray beams included in the diffused light WL1 emitted from the light intensity distribution change unit 100 decreasing and unevenness of the in-plane illuminance increasing.

According to the light intensity distribution change unit 100 of the present embodiment, by arranging a plurality of optical elements 111 in a direction orthogonal to the optical axis 100C, the light intensity distribution of the diffused light WL1 can be finely adjusted in a direction orthogonal to the optical axis 100C. Therefore, unevenness of the in-plane illuminance of the diffused light WL1 can be reduced. In addition, the light intensity distribution change unit 100 can suppress light loss of the diffused light WL1 before and after incidence to a minimum by reflecting the beam transferred to both ends of the beam transfer section 110 with a pair of mirrors 121 and extracting it in the direction along the optical axis 100C.

In the present specification, the diffused light WL1, whose light intensity distribution is changed by the light intensity distribution change unit 100, is referred to as illumination light WL3. The illumination light WL3 emitted from the light intensity distribution change unit 100 is incident on the superimposition optical system 50. The superimposition optical system 50 has a multi-lens array 51 and a superimposing lens 52. The superimposition optical system 50 homogenizes the illumination distribution of the illumination light WL3 in the image forming regions of the light modulation devices 4R, 4G, and 4B arranged in the subsequent stage.

The multi-lens array 51 is arranged on the optical path of the illumination light WL3. The multi-lens array 51 is, for example, a double-sided multi-lens array. The double-sided multi-lens includes a plurality of micro lenses 53 that divide the illumination light WL3 into a plurality of small beams. The plurality of micro lenses 53 are arranged in a matrix adjacent to each other along a plane perpendicular to the optical axis AX10. The micro lenses 53 are, for example, plano convex lenses that are convex toward the incident side. The double-sided multi-lens has a first multi-lens surface 51a provided on the incident side along the shape of the plano convex lenses constituting the micro lenses 53. The double-sided multi-lens includes a plurality of micro lenses 54 that are the same number as the plurality of micro lenses 53 in a plane that is orthogonal to the optical axis AX10. Each micro lens 54 is arranged in a matrix adjacent to one another along a plane perpendicular to the optical axis AX10, and overlaps with each micro lens 53. The micro lenses 54 are, for example, plano convex lenses that are convex toward the emission side. The plane of the emission side of each of the plurality of micro lenses 54 is common to the plane of the incident side of each of the plurality of micro lenses 53. The double-sided multi-lens has a second multi-lens surface 51b provided on the emission side along the shape of the plano convex lenses constituting the micro lenses 54.

The superimposing lens 52 condenses each of the plurality of small beams of the illumination light WL3 emitted from the multi-lens array 51, and in cooperation with the plurality of micro lenses 54 of the multi-lens array 51, superimposes them on each other in the image forming region of each of the light modulation devices 4R, 4G, and 4B, or in the vicinity of the image forming region. The superimposing lens 52 is, for example, a plano convex lens, but may be an optical element having a light condensing function other than the plano convex lens, may be a biconvex lens, or may be composed of multiple optical lenses.

In the projector 1 according to the present embodiment, since each color light LR, LG, and LB included in the white light WL is coherent light, there is a possibility that light interference may occur. In the present embodiment, the illumination device 2 homogenizes the light distribution of the light projected onto the screen SCR by diffusing the white light WL using the diffusion member 41 of the diffusion device 40, and further reduces speckle noise by temporally superimposing the spatial distribution of the speckle noise, which changes every moment, by rotating the diffusion member 41.

However, it is difficult to sufficiently reduce the speckle noise only by the diffusion member 41. The present discloser has paid attention to the fact that speckle noise can be further reduced by adjusting the light intensity distribution of the exit pupil image of the projection lens of the projector. Specifically, the present discloser has completed the projector 1 of the present embodiment that has a structure that can further reduce speckle noise by adjusting the light intensity distribution of the exit pupil image of the projection lens so that the light intensity of the peripheral portion is higher than the light intensity of the central portion.

Hereinafter, a specific operation and effects of the projector 1 of the present embodiment will be described. In the projector 1 according to the present embodiment, the second multi-lens surface 51b, which is the light emission surface of the multi-lens array 51, has an optically conjugated relationship with the exit pupil of the projection optical device 6. In the present embodiment, the projector 1 is adjusted so that the light intensity distribution in the second multi-lens surface 51b of multi-lens array 51, which is conjugate with the exit pupil of projection optical device 6, is such that its light intensity in the peripheral portion is higher than its light intensity in the central portion.

Specifically, in the present embodiment, the projector 1 can generate illumination light WL3 having a light intensity distribution in which the light intensity of the peripheral portion is higher than that of the central portion by splitting at least a part of the central beam of the diffused light WL1 to the peripheral side by the light intensity distribution change unit 100, and cause the illumination light WL3 to be incident on the multi-lens array 51. By this, the illumination light WL3 forms an image on the light emission surface (second multi-lens surface 51b) of the multi-lens array 51 that has a light intensity distribution in which the light intensity of the peripheral portion is higher than that of the central portion. In other words, the illumination light WL3 can form an image on the exit pupil of the projection optical device 6, which is optically conjugate with the light emission surface of the multi-lens array 51, that has a light intensity distribution in which the light intensity of the peripheral portion is higher than that of the central portion.

Therefore, according to the present embodiment, the projector 1 can more effectively reduce speckle noise by forming the exit pupil image having the light intensity distribution in which the light intensity of the peripheral portion is higher than the light intensity of the central portion on the exit pupil of projection optical device 6.

In the projector 1 of the present embodiment, in the light intensity distribution change unit 100, the angle of incidence of the diffused light WL1 with respect to the light intensity distribution change unit 100 before the light intensity distribution is changed is equal to the angle of emergence of the diffused light WL1 from the light intensity distribution change unit 100 after the light intensity distribution is changed. Therefore, the light intensity distribution change unit 100 can generate the illumination light WL3 in which the light intensity distribution of the diffused light WL1 was changed without changing the parallel state of the diffused light WL1 before and after the incidence.

Here, as a comparative example, a case where the parallel state of the illumination light WL3 transmitted through the light intensity distribution change unit 100 has changed will be described. If the parallel state of the illumination light WL3 changes before and after the incidence into the light intensity distribution change unit 100, the image forming state of the each color illumination light RL, GL, and BL that illuminates each image forming region of the light modulation devices 4R, 4G, and 4B by the superimposition optical system 50 changes. As a result, the color illumination lights RL, GL, and BL cannot efficiently illuminate the respective image forming regions, and the image quality of the image projected on the screen SCR deteriorates.

On the other hand, according to the projector 1 of the present embodiment, the parallel state of the illumination light WL3 transmitted through the light intensity distribution change unit 100 does not change, so the image forming state of each color illumination light RL, GL, BL that illuminates the each image forming region of the light modulation devices 4R, 4G, 4B by the superimposition optical system 50 does not change. Therefore, the projector 1 can efficiently illuminate each image forming region to project a bright, high-quality image without blurring on the screen SCR.

### Second Embodiment

Next, a second embodiment of the projector of the present disclosure will be described. The projector of the present embodiment and the projector of the first embodiment differ in the configuration of the light intensity distribution change unit, and the other configurations are common to each other. Therefore, the following mainly explains the configuration of the light intensity distribution change unit, and the same reference numerals are denoted for common parts and configurations, and the detailed explanations are omitted.

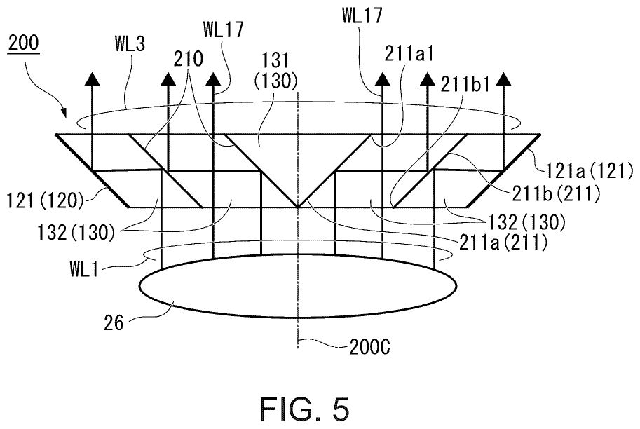

FIG. 5 is a diagram showing the main structure of the light intensity distribution change unit 200 of the present embodiment. As shown in FIG. 5, the light intensity distribution change unit 200 has a beam transfer section 210 having a plurality of optical elements 211, a reflection section 120, and a plurality of prisms 130. An optical axis passing through the center of the light intensity distribution change unit 200 is referred to as an optical axis 200C.

In this embodiment, each optical element 211 is composed of a mirror that reflects light incident. Each optical element 211, in the same way as each mirror 121 that forms the reflection section 120, is composed of a metal film or a dielectric multilayer film or the like. In other words, each optical element 211 reflects the light incident without transmitting it, unlike the optical element 111 formed of a half mirror in the first embodiment.

In the present embodiment, the plurality of optical elements 211 are arranged such that two optical elements 211 adjacent to each other in the direction orthogonal to the optical axis 200C do not overlap each other in the direction along the optical axis 200C.

In FIG. 5, assuming that, among the plurality of the optical elements 211, one of the optical elements 211 held by the first prism 131 is referred to as the first optical element 211a, the optical element 211 arranged on the opposite side (right side in FIG. 5) of the optical axis 200C than the first optical element 211a is referred to as the second optical element 211b, and the mirror 121 arranged on the opposite side (right side in FIG. 5) of the optical axis 200C than the second optical element 211b is referred to as mirror 121a.

Specifically, an end section 211a1 of the emission side of the first optical element 211a and an end section 211b1 of the incident side of the second optical element 211b are, so as not to overlap in a direction along the optical axis 200C, arranged with a gap in the left-right direction of FIG. 5, which is perpendicular to the optical axis 200C.

In the light intensity distribution change unit 200 of the present embodiment, each optical element 211 is a mirror that does not have light transmissivity. By this, according to the light intensity distribution change unit 200 of the present embodiment, the mirrors are arranged on the optical axis 200C and in the vicinity of the optical axis 200C, so the most of the beams in the peripheral portion of the optical axis 200C can be split to the peripheral side. Therefore, the light intensity distribution change unit 200 of the present embodiment, as compared with the light intensity distribution change unit 100 of the first embodiment, can further cause the light intensity of the central portion of the illumination light WL3 to be reduced.

Here, a case where there is no gap between the optical elements 211 adjacent to each other in the left-right direction of FIG. 5 will be described. In this case, the number of light ray beams included in the illumination light WL3 emitted from the light intensity distribution change unit 200 decreases. As a result, unevenness of the in-plane illuminance of the illumination light WL3 increases, and even when using the superimposition optical system 50, it becomes difficult to uniformly illuminate the each image forming region of the light modulation devices 4R, 4G and 4B.

In contrast, in the present embodiment, the light intensity distribution change unit 200 can suppress to reduce the light ray beams included in the illumination light WL3 by emitting the light that has passed through the gap between the adjacent optical elements 211, that is a part of the diffused light WL1, as the transmitted component WL17. By doing this, it is possible to suppress the occurrence of problems caused by increased unevenness of the in-plane illuminance of the illumination light WL3. Note that, the second optical element 211b and the mirror 121a may be arranged with a gap in the left-right direction of FIG. 5.

Therefore, even in the projector using the light intensity distribution change unit 200 of the present embodiment, the projector can form an exit pupil image on the exit pupil of the projection optical device 6 that has a light intensity distribution where its peripheral light intensity is higher than that of the central light intensity, and effectively reduce the speckle noise.

The technical scope of the present disclosure is not limited to the above-described embodiment, and various modifications can be made without departing from the spirit of the present disclosure. In the above embodiment, the light intensity distribution change unit 100 and 200 are both composed of a prism array that includes a plurality of prisms 130, but the configuration of the light intensity distribution change unit of the present disclosure is not limited to this. For example, the light intensity distribution change unit may be composed of a beam transfer section and a reflection section. In this case, for example, the plurality of optical elements constituting the beam transfer section and the plurality of mirrors constituting the reflection section may be arranged at a predetermined position by, instead of the prism, a housing (not shown) or the like that holds other optical members of the illumination device.

When a prism array is used as in the above embodiment, the thickness of each optical element constituting the beam transfer section and the thickness of each mirror constituting the reflection section can be reduced. In contrast, when the optical elements and the mirrors are not held in place by a prism, the optical elements and the mirrors need to be made of metal plate in order to maintain a required rigidity. However, the end surfaces of the optical elements and the mirrors that are made of metal plate have a predetermined thickness, so there is a possibility that light loss is caused by scattering or reflecting the light incident. Therefore, when priority is given to reducing the light loss of the light intensity distribution change unit, it is desirable to use a prism array as in the above embodiment.

The illumination device 2 in the above embodiment is equipped with a rotation type diffusion device 40, but the diffusion device 40 does not necessarily have to have a rotatable diffusion member 41, and it can be fixed type. The diffusion device 40 is a reflection type diffusion device that diffuses and reflects the incident white light WL, but a transmission type diffusion device may be used that diffuses and transmits the incident white light WL.

The projector in the above embodiment is an example where the white light WL of coherent light is emitted from the illumination device 2 and diffused by the diffusion device 40, and the diffused light WL1 diffused by the diffusion device 40 is incident on the light intensity distribution change unit 100 or 200, but the present disclosure is not limited to this. For example, the present disclosure may be applied to a single-color type projector having an illumination device that emits monochromatic illumination light and one light modulation device. Note that when applying the present disclosure to a single-color type projector, it is desirable to apply it to a projector that displays a red image by modulating red diffused light transmitted through the light intensity distribution change unit, by causing the red diffused light, which is diffused the red illumination light that is prone to noticeable speckle noise, to be incident on the light intensity distribution change unit. By doing this, it is possible to reduce the speckle noise of red light, which is highly visible to the human eye. Therefore, the effect of reducing speckle noise can be obtained efficiently.

The specific descriptions of the shape, number, arrangement, material, and the like for each part of the illumination device and the projector are not limited to the above-mentioned embodiments and can be appropriately modified. The present disclosure may be applied to a projector using a digital micromirror device as the light modulation device. The projector according to the present disclosure may not have a plurality of light modulation devices, and may be a single-plate type projector having only one light modulation device.

### Summary of the Present Disclosure

Hereinafter, a summary of the present disclosure is supplementarily noted.

### Supplemental Note 1

A projector includes a first light source for emitting a first laser light; a condenser element configured to condense the first laser light; a diffusion member onto which the first laser light condensed by the condenser element is incident; a collimating element that collimates diffused light emitted from the diffusion member; a light intensity distribution change unit configured to change light intensity distribution of the diffused light by splitting, to a peripheral side, at least a part of the central beam of the diffused light incident from the collimating element; a multi-lens array into which the light emitted from the light intensity distribution change unit is incident; a light modulation device for modulating light incident from the multi-lens array according to image information; a superimposing lens that superimposes the light emitted from the multi-lens array into the light modulation device; and a projection optical device that projects light modulated by the light modulation device, wherein in the light intensity distribution change unit, an angle of incidence of the diffused light with respect to the light intensity distribution change unit before the light intensity distribution is changed, and an angle of emergence of the diffused light with respect to the light intensity distribution change unit after the light intensity distribution is changed are equal.

According to the projector of this configuration, by using the light intensity distribution change unit to split at least a part of the central beam of the diffused light to the peripheral side, it is possible to cause the light that has a light intensity distribution in which its light intensity of the peripheral portion is higher than that of the central portion to be incident on the multi-lens array. By this, it is possible to form an image on the exit pupil of the projection optical device that has a light intensity distribution in which the light intensity of the peripheral portion is higher than that of the central portion. Therefore, according to this configuration, the projector can form the exit pupil image on the exit pupil of the projection optical device that has the light intensity distribution in which the light intensity of the peripheral portion is higher than that of the central portion, and can more effectively reduce the speckle noise of the first laser light. In addition, in the projector with this configuration, the parallel state of the light transmitted through the light intensity distribution change unit does not change, so the imaging state of the light modulation device by the superimposing lens does not change. Therefore, it is possible to project a bright and high-quality image without blurring on the projection surface by efficiently illuminating the light modulation device.

### Supplemental Note 2

The projector according to supplemental note 1 above, wherein the light intensity distribution change unit has a beam transfer section that is arranged symmetrically with respect to an optical axis and directs at least a part of beam of light incident in a direction away from the optical axis and a reflection section that is arranged on an opposite side of the optical axis than the beam transfer section and that reflects light incident from the beam transfer section in a direction along the optical axis.

According to this configuration, the central beam of the diffused light that was split to the peripheral portion by the beam transfer section can be emitted in the direction along the optical axis by the reflection section. By this, the light intensity distribution change unit can cause the light having a light intensity distribution in which the light intensity of the peripheral portion is higher than that of the central portion to be incident on the multi-lens array.

### Supplemental Note 3

The projector according to supplemental note 2 above, wherein the beam transfer section has a plurality of optical elements arranged in a direction orthogonal to the optical axis and the reflection section has a pair of mirrors that sandwich both ends of the beam transfer section in the direction orthogonal to the optical axis.

According to this configuration, the light intensity distribution of the diffused light can be finely adjusted in the direction orthogonal to the optical axis. In addition, by extracting the beam transferred to both ends of the beam transfer section with a pair of mirrors and extracting it in a direction along the optical axis, it is possible to minimize the light loss before and after the light is incident on the light intensity distribution change unit.

### Supplemental Note 4

The projector according to supplemental note 3 above, wherein each of the plurality of optical elements is a partially transmissive mirror that transmits a part of the light incident and reflects an other part of the light incident.

According to this configuration, since each optical element consists of a partially transmissive mirror, light transmitted through each optical element can be extracted. Therefore, it is possible to suppress the occurrence of problems such as increasing unevenness of in-plane illuminance due to the reduced light ray beams included in the light emitted from the light intensity distribution change unit.

### Supplemental Note 5

The projector according to supplemental note 3 or 4 above, wherein the light intensity distribution change unit has a plurality of prisms that hold the plurality of optical elements and the pair of mirrors.

According to this configuration, it is possible to configure the light intensity distribution change unit by the prism array that holds a plurality of optical elements and a pair of mirrors by using a plurality of prisms. Therefore, it is possible to realize a structure in which the plurality of optical elements and the plurality of mirrors are arranged at predetermined positions with high accuracy. In addition, the thickness of each optical element constituting the beam transfer section and the thickness of each mirror constituting the reflection section can be reduced. Therefore, it is possible to suppress the occurrence of light loss by scattering or reflecting light by the end surface of each optical element or each mirror.

### Supplemental Note 6

The projector according to any one of supplemental notes 3 to 5 above, wherein each of the plurality of optical elements is configured with a mirror and at least one of the two optical elements adjacent to each other in the direction orthogonal to the optical axis is arranged so as not to overlap each other in the direction along the optical axis.

According to this configuration, since a part of the diffused light is emitted by passing through the gap between the adjacent optical elements, a decrease of the light ray beams included in the light transmitted through the light intensity distribution change unit can be suppressed. Therefore, it is possible to suppress the occurrence of problems caused by increased unevenness of the in-plane illuminance unevenness of the light transmitted through the light intensity distribution change unit.

### Supplemental Note 7

The projector according to any one of supplemental notes 1 to 6 above, wherein a light emission surface of the multi-lens array and an exit pupil of the projection optical device are optically conjugate.

According to this configuration, it is possible to realize a configuration in which the light intensity distribution on the exit pupil of the projection optical device is adjusted by controlling the light intensity distribution on the light emission surface of the multi-lens array by the light intensity distribution change unit.

### Supplemental Note 8

The projector according to any one of supplemental notes 1 to 7 above, wherein the first laser light is red light.

According to this configuration, it is possible to reduce speckle noise of red light, which is highly visible to humans. Therefore, the effect of reducing speckle noise can be obtained efficiently.

### Supplemental Note 9

The projector according to any one of supplemental notes 1 to 8 above, further including a second light source configured to emit second laser light having a wavelength band different from that of the first laser light and a light combining member configured to emit combined light obtained by combining the first laser light and the second laser light, wherein the combined light emitted from the light combining member is condensed by the condenser element and is incident on the diffusion member and the diffused light of the combined light emitted from the diffusion member is incident on the light intensity distribution change unit through the collimating element.

According to this configuration, it is possible to reduce speckle noise of the combined light obtained by combining the first laser light and the second laser light. Therefore, it is possible to provide a projector in which the speckle noise of light of two different colors is reduced.

What is claimed is:

1. A projector comprising:
a first light source for emitting a first laser light;
a condenser element configured to condense the first laser light;
a diffusion member onto which the first laser light condensed by the condenser element is incident;
a collimating element that collimates diffused light emitted from the diffusion member;
a light intensity distribution change unit configured to change light intensity distribution of the diffused light by splitting, to a peripheral side, at least a part of the central beam of the diffused light incident from the collimating element;
a multi-lens array into which the light emitted from the light intensity distribution change unit is incident;
a light modulation device for modulating light incident from the multi-lens array according to image information;
a superimposing lens that superimposes the light emitted from the multi-lens array into the light modulation device; and
a projection optical device that projects light modulated by the light modulation device, wherein
in the light intensity distribution change unit, an angle of incidence of the diffused light with respect to the light intensity distribution change unit before the light intensity distribution is changed, and an angle of emergence of the diffused light with respect to the light intensity distribution change unit after the light intensity distribution is changed are equal.

2. The projector according to claim 1, wherein
the light intensity distribution change unit has
a beam transfer section that is arranged symmetrically with respect to an optical axis and directs at least a part of beam of light incident in a direction away from the optical axis and
a reflection section that is arranged on an opposite side of the optical axis than the beam transfer section and that reflects light incident from the beam transfer section in a direction along the optical axis.

3. The projector according to claim 2, wherein
the beam transfer section has a plurality of optical elements arranged in a direction orthogonal to the optical axis and
the reflection section has a pair of mirrors that sandwich both ends of the beam transfer section in the direction orthogonal to the optical axis.

4. The projector according to claim 3, wherein
each of the plurality of optical elements is a partially transmissive mirror that transmits a part of the light incident and reflects an other part of the light incident.

5. The projector according to claim 3, wherein
the light intensity distribution change unit has a plurality of prisms that hold the plurality of optical elements and the pair of mirrors.

6. The projector according to claim 3, wherein
each of the plurality of optical elements is configured with a mirror and
at least one of the two optical elements adjacent to each other in the direction orthogonal to the optical axis is arranged so as not to overlap each other in the direction along the optical axis.

7. The projector according to claim 1, wherein
a light emission surface of the multi-lens array and an exit pupil of the projection optical device are optically conjugate.

8. The projector according to claim 1, wherein the first laser light is red light.

9. The projector according to claim 1, further comprising:
a second light source configured to emit second laser light having a wavelength band different from that of the first laser light and
a light combining member configured to emit combined light obtained by combining the first laser light and the second laser light, wherein
the combined light emitted from the light combining member is condensed by the condenser element and is incident on the diffusion member and
the diffused light of the combined light emitted from the diffusion member is incident on the light intensity distribution change unit through the collimating element.
